(19) United States
(12) Patent Application Publication
(10) Pub. No.: US 2026/0369509 A1
(43) Pub. Date: Nov. 19, 2026

(54) ULTRA-MINIATURE SURFACE-MOUNT FUSE STRUCTURE AND MANUFACTURING PROCESS THEREOF

(71) Applicant: SHENZHEN VICTORS INDUSTRIAL CO., LTD., Shenzhen (CN)

(72) Inventors: Ming HAO, Shenzhen (CN); Fuquan HAO, Shenzhen (CN)

(21) Appl. No.: 19/675,565

(22) Filed: May 13, 2026

Related U.S. Application Data
(63) Continuation of application No. PCT/CN2025/140576, filed on Dec. 6, 2025.

(30) Foreign Application Priority Data
May 14, 2025 (CN) 202510618361.0

(51) Int. Cl. H01H 85/041; H01H 69/02; H01H 85/08; H01H 85/147; H01H 85/17; H01H 85/20

(52) U.S. Cl. CPC H01H 85/0417; H01H 69/022; H01H 85/08; H01H 85/147; H01H 85/17; H01H 85/2045; H01H 2069/027; H01H 2085/0414

(57) ABSTRACT

An ultra-miniature surface-mount fuse structure including a ceramic substrate, two internal electrode components, two end electrode components, a fuse element, and a covering protection layer, wherein a side wall of the ceramic substrate is formed with two internal electrode grooves; the two internal electrode components include a first internal electrode and a second internal electrode; and the first internal electrode and the second internal electrode are each formed with a fuse retaining groove. A manufacturing process for the ultra-miniature surface-mount fuse structure includes: forming the two internal electrode grooves at both ends of the ceramic substrate; constructing the first internal electrode and the second internal electrode, inserting the fuse element into fuse retaining grooves and connecting the same by thermosonic wedge bonding or thermocompression bonding, printing and curing the covering protection layer, and segmenting the ceramic substrate and forming the first end electrode and the second end electrode.

### CROSS-REFERENCE TO RELATED APPLICATIONS

The present application is a continuation application of PCT application No. PCT/CN 2025/140576, filed on Dec. 6, 2025, which claims priority to Chinese patent application No. 202510618361.0, filed on May 14, 2025. The entireties of PCT application No. PCT/CN 2025/140576 and Chinese patent application No. 202510618361.0 are hereby incorporated by reference herein and made a part of this specification.

### TECHNICAL FIELD

The present application relates to the technical field of electronic components, and specifically relates to an ultra-miniature surface-mount fuse structure and a manufacturing process thereof.

### BACKGROUND ART

As core protection components in electronic circuits, surface-mount fuses are widely used in high-density electronic devices such as communications equipment, smart terminals, medical electronics, automotive electronics, and industrial control. Their primary function is to provide rapid fusing protection when an overcurrent or short-circuit fault occurs in a circuit. As electronic products evolve toward miniaturization, higher performance, and greater integration, the market is placing higher requirements on the size, performance, and consistency of surface-mount fuses.

Especially in ultra-miniature devices such as those of 0201 size (0.6 mm×0.3 mm), due to a very small physical structure of surface-mount fuses and limited operable space, conventional fabrication processes suffer from problems such as poor process precision control and unstable connections. In particular, during fuse construction and internal electrode connection processes, small parameter deviations can be magnified, severely affecting a product's electrical performance and long-term reliability, making it difficult to meet the stringent requirements of modern electronic devices for highly reliable, miniaturized fuse devices.

### SUMMARY

To address the shortcomings of low fabrication precision and poor fuse connection stability of existing surface-mount fuses in ultra-miniature sizes, the present application provides an ultra-miniature surface-mount fuse structure and a manufacturing process thereof.

An ultra-miniature surface-mount fuse structure includes a ceramic substrate, two internal electrode components inserted into the ceramic substrate, two end electrode components connected to both ends of the ceramic substrate and configured to connect to the two internal electrode components, a fuse element located between the two end electrode components and configured to connect the two internal electrode components, and a covering protection layer overlying an outer periphery of the fuse element and located between the two end electrode components;
wherein a side wall of the ceramic substrate is formed with two internal electrode grooves which are respectively located at the both ends of the ceramic substrate; the two internal electrode components include a first internal electrode and a second internal electrode which are respectively inserted into the two internal electrode grooves; the first internal electrode and the second internal electrode are each formed with a fuse retaining groove; and both ends of the fuse element are respectively inserted into the fuse retaining grooves in the first internal electrode and the second internal electrode, and are respectively connected to the first internal electrode and the second internal electrode.

Preferably, the first internal electrode and the second internal electrode each include an internal electrode metal layer covering an inner wall of a corresponding internal electrode groove, and a connecting metal layer connected to the internal electrode metal layer and covering a peripheral side of an open end of the corresponding internal electrode groove; and the internal electrode metal layer is connected to a corresponding end of the fuse element, and the connecting metal layer is connected to a corresponding end electrode component.

Preferably, the two internal electrode grooves respectively include a first internal electrode groove located at a first end of the ceramic substrate and a second internal electrode groove located at a second end of the ceramic substrate; and the first internal electrode is inserted into the first internal electrode groove, and the second internal electrode is inserted into the second internal electrode groove.

Preferably, the two end electrode components respectively include a first end electrode connected to the first internal electrode and a second end electrode connected to the second internal electrode.

Preferably, the first end electrode and the second end electrode each include an end electrode body connected to a corresponding end surface of the ceramic substrate, a connecting side edge connected to a first side of the end electrode body and connected to a corresponding internal electrode component, and a fixing side edge connected to a second side of the end electrode body and connected to a side wall of the ceramic substrate; and
the covering protection layer overlies the outer periphery of the fuse element, and both ends of the covering protection layer are respectively connected to the connecting side edges of the first end electrode and the second end electrode.

A manufacturing process for the ultra-miniature surface-mount fuse structure, including the following steps:

S1: forming the two internal electrode grooves at both ends of one side of the ceramic substrate using an etching process;

S2: performing a wall-deposited metallization forming process on an inner wall of each internal electrode groove and a peripheral side of an open end of each internal electrode groove to form the two internal electrode components;

S3: inserting both ends of the fuse element respectively into two of the fuse retaining grooves, and connecting the both ends of the fuse element respectively to the first internal electrode and the second internal electrode by thermosonic wedge bonding or thermocompression bonding;

S4: printing a protection layer material on the outer periphery of the fuse element and curing the protection layer material to form the covering protection layer; and

S5: segmenting the ceramic substrate and performing metallization on the end electrode components to form external electrodes electrically connected to the internal electrode components.

Preferably, the etching process is photolithography and inductively coupled plasma etching technology.

Preferably, the wall-deposited metallization forming process is performed by atomic layer deposition or physical vapor deposition.

Preferably, the thermosonic wedge bonding includes the following steps:

S301: positioning bonding locations between the fuse element and the internal electrode components by using an optical positioning system, and guiding the fuse element for placement;

S302: adjusting an ultrasonic power to a preset value based on dimensions of the ceramic substrate and metal wire material properties of the fuse element;

S303: monitoring and adjusting a bonding pressure in real time by a pressure control system with pneumatic pressure feedback, such that the bonding pressure is uniformly distributed in contact areas between the fuse element and the internal electrode components; and

S304: adjusting a bonding duration to a preset bonding time.

Preferably, the thermocompression bonding includes the following steps:

S311: adjusting a bonding temperature to a range of 150 °C to 250 °C by a heating structure and a temperature control system of a thermocompression bonding apparatus and setting temperature uniformity within ±2 °C;

S312: adjusting a heating temperature and an applied pressure based on metallic properties of the fuse element and the internal electrode components to form an intermetallic compound layer at a contact interface between the fuse element and the internal electrode components; and

S313: adjusting temperature, pressure, and time parameters based on a combination type of a fuse material of the fuse element and a material of the internal electrode components to perform connection.

### BRIEF DESCRIPTION OF THE DRAWINGS

FIG. 1 is an exploded view of an embodiment of an ultra-miniature surface-mount fuse structure of the present application.

FIG. 2 is a cross-sectional view of the embodiment of the ultra-miniature surface-mount fuse structure of the present application.

FIG. 3 is a flow diagram of an embodiment of a manufacturing process for the ultra-miniature surface-mount fuse structure of the present application.

FIG. 4 is a flow diagram of thermosonic wedge bonding in the embodiment of the manufacturing process for the ultra-miniature surface-mount fuse structure of the present application.

FIG. 5 is a flow diagram of thermocompression bonding in the embodiment of the manufacturing process for an ultra-miniature surface-mount fuse structure of the present application.

### DETAILED DESCRIPTION

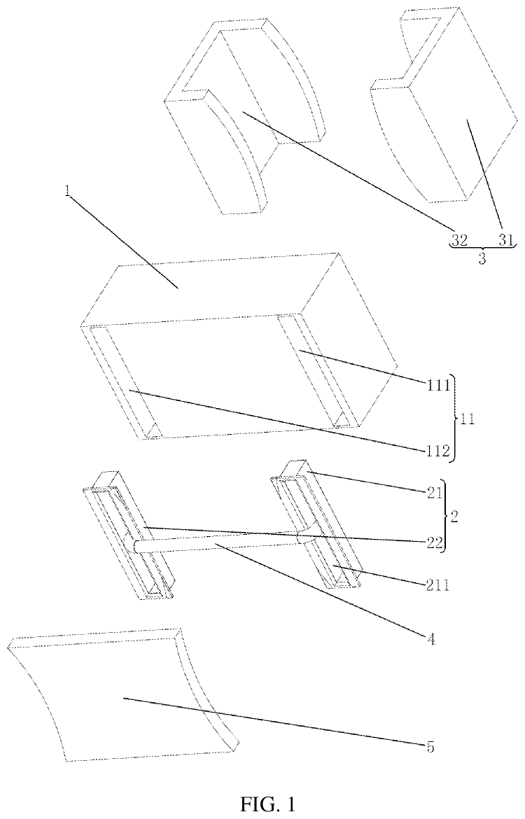

The present application is further described below with reference to FIGS. 1 to 5.

The present application discloses an ultra-miniature surface-mount fuse structure and a manufacturing method thereof. Referring to FIG. 1, an ultra-miniature surface-mount fuse structure includes a ceramic substrate 1, two internal electrode components 2 inserted into the ceramic substrate 1, two end electrode components 3 connected to both ends of the ceramic substrate 1 and configured to connect to the two internal electrode components 2, a fuse element 4 located between the two end electrode components 3 and configured to connect the two internal electrode components 2, and a covering protection layer 5 covering a peripheral side of the fuse element 4 and located between the two end electrode components 3.

A side wall of the ceramic substrate 1 is formed with two internal electrode grooves 11 which are respectively located at the both ends of the ceramic substrate 1. The two internal electrode components 2 include a first internal electrode 21 and a second internal electrode 22 which are respectively inserted into the two internal electrode grooves 11. The first internal electrode 21 and the second internal electrode 22 are each formed with a fuse retaining groove 211. Both ends of the fuse element 4 are respectively inserted into the fuse retaining grooves 211 in the first internal electrode 21 and the second internal electrode 22, and are respectively connected to the first internal electrode 21 and the second internal electrode 22.

In the present application, the ceramic substrate 1 serves as an overall support structure, and the first internal electrode 21 and the second internal electrode 22 are respectively inserted into the internal electrode grooves 11 located in the side wall at the both ends of the ceramic substrate 1 to achieve stable positioning. Both ends of the fuse element 4 are respectively inserted into the fuse retaining grooves 211 in the first internal electrode 21 and the second internal electrode 22, thereby achieving a precise connection between the fuse element 4 and the internal electrode components 2. The end electrode components 3 are respectively connected to the both ends of the ceramic substrate 1 and electrically connected to the internal electrode components 2, allowing surface-mount soldering to an external circuit. The covering protection layer 5 is arranged at the peripheral side of the fuse element 4 and located between the two end electrode components 3, to provide insulation and mechanical protection for the fuse element 4. In the overall structure of the present application, precise defining of connection points of the fuse element 4 and anti-detachment protection thereof are achieved through cooperation with the fuse retaining grooves 211. This not only improves the structural stability and electrical connection reliability between the fuse element 4 and the first internal electrode 21 and second internal electrode 22, but also improves the thermal resistance, consistency, and mass production capability of the entire fuse device in high-density mounting and miniaturized electronic applications, thereby effectively ensuring circuit overcurrent protection performance in the structure of an ultra-small size such as 0201 size.

The present application is primarily intended for the production and manufacturing of “ultra-miniature” fuses. Semiconductor processes such as printing technology and etching process used for conventional ultra-miniature fuses are costly, complex, and difficult in environmental treatment. The present application uses semiconductor bonding technology, simplifying the manufacturing process, and converting a chemical manufacturing process into a physical process, thereby avoiding pollution while improving manufacturing efficiency and environmental friendliness.

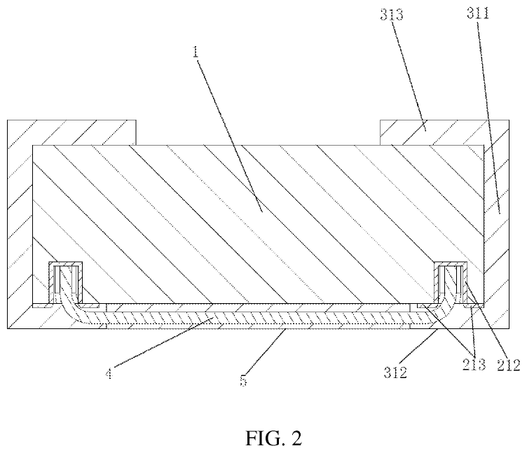

Further, as shown in FIG. 2, the first internal electrode 21 and the second internal electrode 22 each include an internal electrode metal layer 212 covering an inner wall of a corresponding internal electrode groove 11, and a connecting metal layer 213 connected to the internal electrode metal layer 212 and covering a peripheral side of an open end of the corresponding internal electrode groove 11. The internal electrode metal layer 212 is connected to a corresponding end of the fuse element 4, and the connecting metal layer 213 is connected to a corresponding end electrode component 3.

In the present application, the first internal electrode 21 and the second internal electrode 22 each use the internal electrode metal layer 212 deposited on the inner wall of the corresponding internal electrode groove 11 as a direct connection surface with the fuse element 4, and each of the both ends of the fuse element 4 is soldered or bonded to a corresponding internal electrode metal layer 212 to achieve stable conduction. The internal electrode metal layer 212 extends outward to the open end of the groove and bends to cover a portion of the surface of the ceramic substrate 1, thereby forming the connecting metal layer 213. The connecting metal layer 213 is configured to connect to a corresponding end electrode component 3, forming a complete electrical path from the fuse element 4 through the internal electrode metal layer 212 and the connecting metal layer 213 to the end electrode component 3. The structure of the present application achieves a multi-segment reliable-conduction connection mode, improving the stability of current transmission and structural strength. The arrangement of the metal layers in both regions of the inner wall and the open end of the groove not only increases the effective soldering area of the fuse element 4 and increases bonding consistency and electrical contact area, but also facilitates pad positioning of the end electrode component 3 and a soldering operation, thereby enhancing reliable fusing characteristics of the element under overcurrent conditions and connection reliability during long-term use, while ensuring the compactness of the ultra-miniature structure.

The internal electrode metal layer 212 is arranged along a peripheral side of the internal electrode groove 11 to form a fuse retaining groove 211.

Still further, as shown in FIG. 1, the two internal electrode grooves 11 respectively include a first internal electrode groove 111 located at a first end of the ceramic substrate 1 and a second internal electrode groove 112 located at a second end of the ceramic substrate 1, to form a complete structure of the internal electrode grooves 11. The first internal electrode 21 is inserted into the first internal electrode groove 111, and the second internal electrode 22 is inserted into the second internal electrode groove 112, achieving a symmetrical embedded arrangement of the internal electrode components 2 in the ceramic substrate 1. The first internal electrode 21 is closely fitted to the inner wall of the first internal electrode groove 111, and the second internal electrode 22 is closely fitted to the inner wall of the second internal electrode groove 112, so as to provide stable support and provide a reference for subsequent positioning and connection of the fuse element 4. The embedded structure of the internal electrode components 2 not only enhances the structural stability between the electrodes and the substrate, but also helps control assembly precision, preventing electrode displacement caused by thermal expansion, mechanical stress, or process deviations. This, in turn, improves the overall stability of fuse connection and the consistency of soldering, thereby enhancing the structural reliability, electrical conductivity, and thermal shock resistance of the ultra-miniature surface-mount fuse in high-density assembly and long-term operating environments.

Specifically, as shown in FIG. 1, the two end electrode components 3 respectively include a first end electrode 31 connected to the first internal electrode 21 and a second end electrode 32 connected to the second internal electrode 22.

The first end electrode 31 is connected to an outer extension end of the first internal electrode 21, and the second end electrode 32 is connected to an outer extension end of the second internal electrode 22. The first end electrode 31 is electrically connected to the first internal electrode 21, and the second end electrode 32 is electrically connected to the second internal electrode 22, through the connecting metal layer 213, thereby establishing a complete current transmission path from the fuse element 4 to external pads. The end electrode components 3 are disposed on outer sides of the both ends of the ceramic substrate 1, and can cover and enclose the ends of the ceramic substrate 1, ensuring sufficient contact area during surface-mount soldering. In practical applications, the first end electrode 31 and the second end electrode 32 serve dual functions of stable mechanical connection and electrical lead-out. This not only enhances the soldering reliability and tensile and shear strength of the device, but also provides a low-impedance path for current conduction. Particularly in miniature sizes such as 0201 size, the dual-end separated structure of the end electrode components 3 effectively mitigates issues such as pad misalignment and cold solder joints caused by high-density encapsulation, thereby enhancing the reliability and consistency of the surface-mount fuse during automated surface-mount production and subsequent circuit operation.

More specifically, as shown in FIG. 2, the first end electrode 31 and the second end electrode 32 each include an end electrode body 311 connected to a corresponding end surface of the ceramic substrate 1, a connecting side edge 312 connected to a first side of the end electrode body 311 and connected to a corresponding internal electrode component 2, and a fixing side edge 313 connected to a second side of the end electrode body 311 and connected to a side wall of the ceramic substrate 1.

The covering protection layer 5 overlies the fuse element 4, and both ends of the covering protection layer 5 are respectively connected to the connecting side edges 312 of the first end electrode 31 and the second end electrode 32.

The end electrode body 311 of the present application is attached to the end surface of the ceramic substrate 1, serving as a main support. The connecting side edge 312 extends from the first side of the end electrode body 311 and is electrically connected to the internal electrode component 2, forming a current lead-out path. The fixing side edge 313 extends from the second side of the end electrode body 311 and covers a side wall of the ceramic substrate 1, serving to implement mechanical fixation to the ceramic substrate 1 and provide overlying protection thereof. The end electrode bodies 311 are fixed to the both ends of the ceramic substrate 1 by hot pressing or sputtering, with each connecting side edge 312 electrically connected to a corresponding connecting metal layer 213, and each fixing side edge 313 fitted to an outer wall of the ceramic substrate 1, thereby forming a stable enclosing connection structure. Moreover, the covering protection layer 5 overlies the fuse element 4, and both ends of the covering protection layer 5 are respectively connected to the connecting side edges 312 of the first end electrode 31 and the second end electrode 32. This not only provides electrical insulation protection and oxidation resistance for the fuse element 4, but also prevents mechanical stress from being directly applied to fuse joints. The overall structural design, through the overlying extension of the electrode side edges and a multi-side supporting configuration, effectively improves the mechanical strength, electrical connection stability, and encapsulation sealing performance of the device.

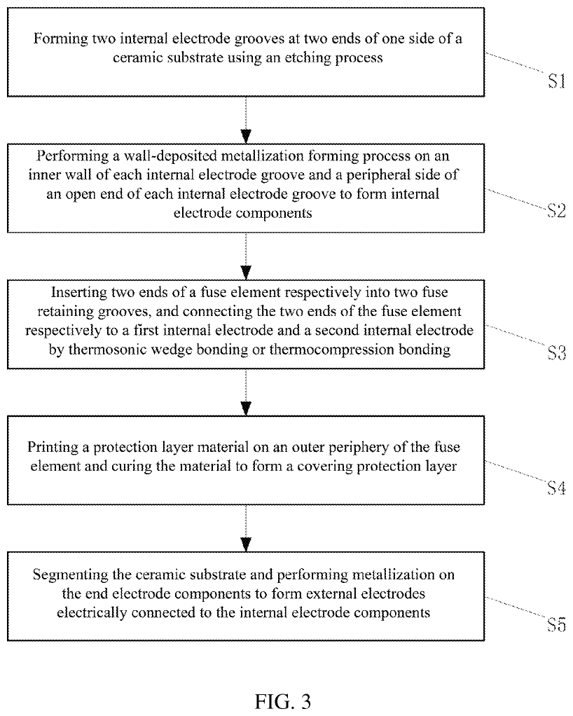

In addition, as shown in FIG. 3, the present application further discloses a manufacturing process for the ultra-miniature surface-mount fuse structure, including the following steps:

S1: forming the two internal electrode grooves 11 at both ends of one side of the ceramic substrate 1 using an etching process;

S2: performing a wall-deposited metallization forming process on an inner wall of each internal electrode groove 11 and a peripheral side of an open end of each internal electrode groove 11 to form the two internal electrode components 2;

S3: inserting both ends of the fuse element 4 respectively into two of the fuse retaining grooves 211, and connecting the both ends of the fuse element 4 respectively to the first internal electrode 21 and the second internal electrode 22 by thermosonic wedge bonding or thermocompression bonding;

S4: printing a protection layer material on an outer periphery of the fuse element 4 and curing the protection layer material to form a covering protection layer 5; and

S5: segmenting the ceramic substrate 1 and performing metallization on the end electrode components 3 to form external electrodes electrically connected to the internal electrode components 2.

In the present application, in the step S1, two internal electrode grooves 11 are formed at both ends of one side of the ceramic substrate 1 using the etching process to define the position of the internal electrode components 2, and subsequently, in the step S2, the wall-deposited metallization forming process is performed on the inner wall of each internal electrode groove 11 and the peripheral side region of the open end of each internal electrode groove to form the first internal electrode 21 and the second internal electrode 22 with electrical conductivity and adhesion, thereby constituting complete internal electrode components 2. In the step S3, both ends of the fuse element 4 are respectively inserted into the two fuse retaining grooves 211, and the both ends of the fuse element 4 are respectively firmly connected to the first internal electrode 21 and the second internal electrode 22 by thermosonic wedge bonding or thermocompression bonding, ensuring low impedance, high consistency and reliability of the fuse connection. In the step S4, the protection layer material is printed on the outer periphery of the fuse element 4 and thermally cured to form the covering protection layer 5, thereby providing electrical insulation and mechanical protection for the fuse element 4. In the step S5, the ceramic substrate 1 is segmented and an end electrode metal layer is applied to both ends of the ceramic substrate 1 to form a first end electrode 31 and a second end electrode 32 electrically connected to the connecting metal layer 213, thereby constituting end electrode components 3 and completing a pad connection to an external circuit. The method of the present application overall improves the process consistency, electrical performance stability, structural reliability, and suitability for mass production of an ultra-miniature surface-mount fuse, through precise groove formation, metallization with adhesion formation, electrode embedding and positioning, a bonding process, and a wrap-around protection structure.

The present application is primarily intended for the production and manufacturing of “ultra-miniature” fuses. Semiconductor processes such as printing technology and etching process used for conventional ultra-miniature fuses are costly, complex, and difficult in environmental treatment. The present application uses semiconductor bonding technology, simplifying the manufacturing process, and converting a chemical manufacturing process into a physical process, thereby avoiding pollution while improving manufacturing efficiency and environmental friendliness. Moreover, the method of the present application improves product consistency and effectively ensures the connection stability of the fuse.

In the present application, preferably, the protection layer material of epoxy resin or glass paste is printed on the outer periphery of the fuse element 4 and dried to form the covering protection layer 5.

Raw material of the epoxy resin includes the following components by weight parts:
Bisphenol A epoxy resin: 100 parts
Curing agent: 40-50 parts
Reactive diluent: 3%-8% (based on the weight of the epoxy resin)

The above-mentioned components are weighed according to the parts by weight and mixed uniformly.

Raw material of the glass paste includes the following components by weight percentage:
Silicon dioxide (SiO₂): 50%-65%
Alumina (Al₂O₃): 10%-20%
Boron oxide (B₂O₃): 10%-15%
Flux content: 5%-10%

The components are precisely proportioned, thoroughly mixed, and melted to form the glass paste.

In the step S5, the ceramic substrate 1 of the product is segmented, a copper layer or a silver layer is formed on the ceramic substrate 1 by immersion silver plating or sputtering, and the end electrode components 3 are formed by electroplating or sputtering nickel and tin.

Furthermore, the etching process in the step S1 is photolithography and inductively coupled plasma etching technology.

The present application uses the photolithography and inductively coupled plasma (ICP) etching technology to perform high-precision formation of the internal electrode grooves 11 on the ceramic substrate 1. The specific process involves first applying photoresist to both ends of one side of the ceramic substrate 1 by photolithography, followed by exposure and development to form an etching pattern mask, and then performing anisotropic dry etching on the ceramic substrate 1 along a mask pattern by ICP etching technology, thereby precisely forming the first internal electrode groove 111 and the second internal electrode groove 112, which have structural features of controllable depth, clean edges, and high verticality. Compared with conventional wet etching, the process in the present application can improve the precision and consistency of groove dimension control, thereby avoiding processing defects caused by the hardness and brittleness of ceramic materials or non-uniform etching of the grooves, thereby providing a stable three-dimensional structural basis for subsequent wall-deposited metallization and embedding of the internal electrode components 2, further enhancing the positioning accuracy and connection reliability between the internal electrode components 2 and the fuse element 4, and effectively improving the overall electrical performance, thermal resistance, and mass production adaptability of the device.

The distance between an internal electrode groove 11 and an edge of an end of the ceramic substrate 1 is preferably 5 μm to 10 μm. The shape of the internal electrode groove 11 is preferably rectangular, trapezoidal, or elliptical, with a width of ⅛ to ¼ of the width of the ceramic substrate 1 and a depth of ⅛ to ⅙ of the depth of the ceramic substrate 1.

Further, the wall-deposited metallization forming process in the step S2 is performed by atomic layer deposition or physical vapor deposition.

In the present application, the atomic layer deposition (ALD) or physical vapor deposition (PVD) process is used as the wall-deposited metallization forming process to perform uniform metal deposition on the inner wall and the peripheral side of the open end of each internal electrode groove 11. In the specific procedure, the ALD process involves depositing metal atoms layer by layer onto the groove wall through atomic-level reaction control, thereby forming an internal electrode metal layer 212 and a connecting metal layer 213 with controllable thickness and good coverage. The PVD process involves depositing and adhering a high-purity metal material (such as copper, silver, or an alloy thereof) onto the inner surface of the three-dimensional groove structure through magnetron sputtering or evaporation. During this procedure, metallization layers are firmly adhered to the inner wall and the peripheral side of the open end of each of the first internal electrode groove 111 and the second internal electrode groove 112 formed on the ceramic substrate 1, ensuring that the metal layers form a continuous conductive path within the complex structure, thereby forming a first internal electrode 21 and a second internal electrode 22 with high uniformity, strong adhesion, and low contact resistance. The process steps of the present application not only enhance the electrical conductivity and thermal stability of the internal electrode components 2, but also provide a stable metal interface for subsequent precise connection of the fuse element 4, effectively ensuring reliable fusing behavior of the ultra-miniature surface-mount fuse and long-term operational performance thereof under high-density encapsulation conditions.

A thickness of the internal electrode metal layer 212 and the connecting metal layer 213 is preferably between 0.5 μm and 3 μm.

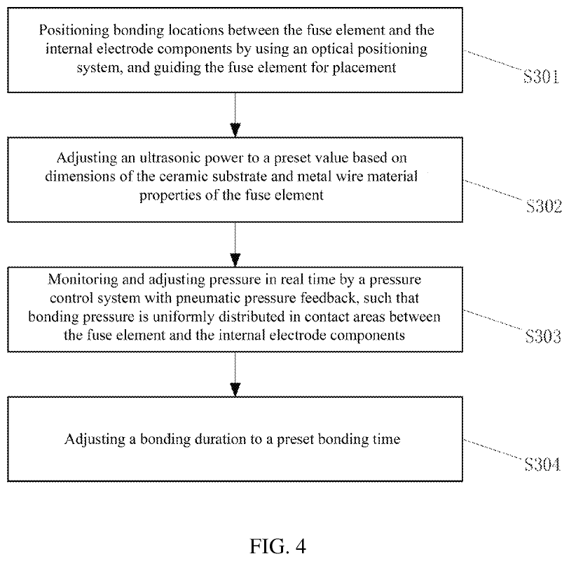

Still further, as shown in FIG. 4, the thermosonic wedge bonding in the step S3 includes the following steps:

S301: positioning bonding locations between the fuse element 4 and the internal electrode components 2 by using an optical positioning system, and guiding the fuse element 4 for placement;

S302: adjusting an ultrasonic power to a preset value based on dimensions of the ceramic substrate 1 and metal wire material properties of the fuse element 4;

S303: monitoring and adjusting a bonding pressure in real time by a pressure control system with pneumatic pressure feedback, such that the bonding pressure is uniformly distributed in contact areas between the fuse element 4 and the internal electrode components 2; and

S304: adjusting a bonding duration to a preset bonding time.

In the present application, in the step S301, the bonding locations between the fuse element 4 and the internal electrode components 2 are precisely identified and positioned by using a high-precision optical positioning system, and the both ends of the fuse element 4 are accurately aligned and placed into the fuse retaining grooves 211 corresponding to the first internal electrode 21 and the second internal electrode 22, thereby ensuring consistent alignment during subsequent bonding. In the step S302, the ultrasonic power is adjusted to a preset range based on specific dimensions of the ceramic substrate 1 and metal wire material properties of the fuse element 4, thereby achieving energy control that both ensures bonding strength and avoids overheating damage. In the step S303, the bonding pressure during bonding is monitored in real time and dynamically adjusted by the pressure control system with pneumatic pressure feedback, such that the pressure applied between the fuse element 4 and the internal electrode components 2 is uniformly distributed in the entire contact areas, thereby effectively preventing localized indentations, cold solder joints, or unstable connections. In bonding S304, a duration of thermosonic bonding is reduced to a parameter range to ensure that metallurgical bonding is completed within a specified time, thereby reducing the impact on thermal-sensitive characteristics of the fuse. In the present application, coordinated regulation of a connection interface between the fuse element 4 and the first internal electrode 21 and second internal electrode 22 in four dimensions of position, energy, pressure, and time is achieved through multidimensional control. This not only substantially enhances the electrical reliability and structural stability of the fuse connection, but also improves process consistency and product yield, thereby providing critical technological support for the mass production of ultra-miniature fuses, such as those of 0201 size, in high-integration, high-reliability electronic applications.

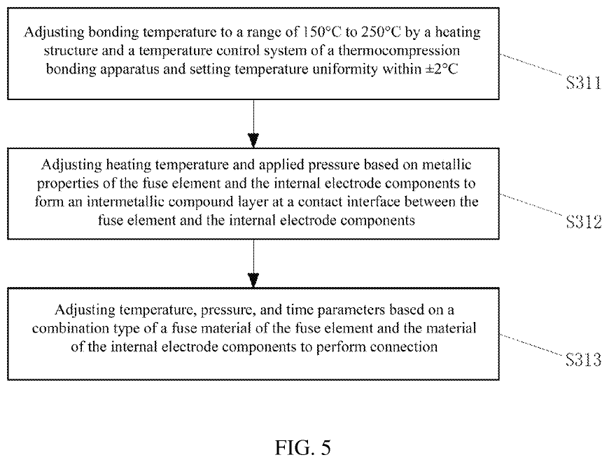

Specifically, as shown in FIG. 5, the thermocompression bonding in the step S3 includes the following steps:

S311: adjusting a bonding temperature to a range of 150 °C to 250 °C by a heating structure and a temperature control system of a thermocompression bonding apparatus and setting temperature uniformity within ±2 °C;

S312: adjusting a heating temperature and an applied pressure based on metallic properties of the fuse element 4 and the internal electrode components 2 to form an intermetallic compound layer at a contact interface between the fuse element 4 and the internal electrode components 2; and

S313: adjusting temperature, pressure, and time parameters based on a combination type of a fuse material of the fuse element 4 and a material of the internal electrode components 2 to perform connection.

In the step S311, the bonding temperature is adjusted to a set range of 150 °C to 250 °C by the thermocompression bonding apparatus through a built-in heating structure and high-precision temperature control system thereof, and temperature uniformity in bonding regions is controlled within ±2 °C to prevent localized overheating or cold solder joints caused by temperature differences. In the step S312, the heating temperature and the applied pressure are precisely adjusted based on metallic material properties of the fuse element 4 and the internal electrode components 2 to form a stable intermetallic compound layer at the contact interface between the fuse element 4 and the first internal electrode 21 and the second internal electrode 22, thereby reducing contact resistance and improving connection strength and thermal stability. In the step S313, bonding temperature, pressure, and duration parameters are dynamically adjusted based on a matching relationship between the fuse material of the fuse element 4 (such as nickel-chromium alloy, copper-aluminum alloy, pure gold wire, or pure palladium wire) and the material of the internal electrode components 2 (such as high-purity copper, silver, or silver alloy) to achieve reliable connections for different material combinations. Through refined control in the dimensions of temperature, pressure, and material matching, the thermocompression bonding step in the present application effectively improves the metallurgical bonding quality, fatigue resistance, and conduction consistency of the fuse connection regions, ensuring that the ultra-miniature surface-mount fuse exhibits excellent electrical stability and manufacturing process compatibility during long-term operation in high-density circuits.

The above are preferred embodiments of the present application, which are not intended to limit the scope of protection of the present application. Therefore, any equivalent changes made based on the structures, shapes, or principles in the present application shall be encompassed within the scope of protection of the present application.

### Listing of Reference Signs

1. Ceramic substrate;
11. Internal electrode groove;
111. First internal electrode groove;
112. Second internal electrode groove;
2. Internal electrode component;
21. First internal electrode;
22. Second internal electrode;
211. Fuse retaining groove;
212. Internal electrode metal layer;
213. Connecting metal layer;
3. End electrode component;
31. First end electrode;
32. Second end electrode;
311. End electrode body;
312. Connecting side edge;
313. Fixing side edge;
4. Fuse element;
5. Covering protection layer.

What is claimed is:

1. An ultra-miniature surface-mount fuse structure, comprising a ceramic substrate, two internal electrode components inserted into the ceramic substrate, two end electrode components connected to both ends of the ceramic substrate and configured to connect to the two internal electrode components, a fuse element located between the two end electrode components and configured to connect the two internal electrode components, and a covering protection layer overlying an outer periphery of the fuse element and located between the two end electrode components;
wherein a side wall of the ceramic substrate is formed with two internal electrode grooves which are respectively located at the both ends of the ceramic substrate; the two internal electrode components comprise a first internal electrode and a second internal electrode which are respectively inserted into the two internal electrode grooves; the first internal electrode and the second internal electrode are each formed with a fuse retaining groove; and both ends of the fuse element are respectively inserted into the fuse retaining grooves in the first internal electrode and the second internal electrode, and the both ends of the fuse element are respectively connected to the first internal electrode and the second internal electrode.

2. The ultra-miniature surface-mount fuse structure according to claim 1, wherein the first internal electrode and the second internal electrode each comprise an internal electrode metal layer covering an inner wall of a corresponding internal electrode groove of the two internal electrode grooves, and a connecting metal layer connected to the internal electrode metal layer and covering a peripheral side of an open end of the corresponding internal electrode groove; and the internal electrode metal layer is connected to a corresponding end of the fuse element, and the connecting metal layer is connected to a corresponding end electrode component of the two end electrode components.

3. The ultra-miniature surface-mount fuse structure according to claim 1, wherein the two internal electrode grooves respectively comprise a first internal electrode groove located at a first end of the ceramic substrate and a second internal electrode groove located at a second end of the ceramic substrate; and the first internal electrode is inserted into the first internal electrode groove, and the second internal electrode is inserted into the second internal electrode groove.

4. The ultra-miniature surface-mount fuse structure according to claim 1, wherein the two end electrode components respectively comprise a first end electrode connected to the first internal electrode and a second end electrode connected to the second internal electrode.

5. The ultra-miniature surface-mount fuse structure according to claim 4, wherein the first end electrode and the second end electrode each comprise an end electrode body connected to a corresponding end surface of the ceramic substrate, a connecting side edge connected to a first side of the end electrode body and connected to a corresponding internal electrode component of the two internal electrode components, and a fixing side edge connected to a second side of the end electrode body and connected to the side wall of the ceramic substrate; and
the covering protection layer overlies the outer periphery of the fuse element, and both ends of the covering protection layer are respectively connected to the connecting side edges of the first end electrode and the second end electrode.

6. A manufacturing process for the ultra-miniature surface-mount fuse structure of claim 1, comprising the following steps:
S1: forming the two internal electrode grooves at both ends of one side of the ceramic substrate using an etching process;
S2: performing a wall-deposited metallization forming process on an inner wall of each of the two internal electrode grooves and a peripheral side of an open end of each of the two internal electrode grooves to form the two internal electrode components;
S3: inserting the both ends of the fuse element respectively into two of the fuse retaining grooves, and connecting the both ends of the fuse element respectively to the first internal electrode and the second internal electrode by thermosonic wedge bonding or thermocompression bonding;
S4: printing a protection layer material on the outer periphery of the fuse element and curing the protection layer material to form the covering protection layer; and
S5: segmenting the ceramic substrate and performing metallization on the two end electrode components to form external electrodes electrically connected to the two internal electrode components.

7. The manufacturing process for an ultra-miniature surface-mount fuse structure according to claim 6, wherein the etching process is photolithography and inductively coupled plasma etching technology.

8. The manufacturing process for an ultra-miniature surface-mount fuse structure according to claim 6, wherein the wall-deposited metallization forming process is performed by atomic layer deposition or physical vapor deposition.

9. The manufacturing process for an ultra-miniature surface-mount fuse structure according to claim 6, wherein the thermosonic wedge bonding comprises the following steps:
S301: positioning bonding locations between the fuse element and the two internal electrode components by using an optical positioning system, and guiding the fuse element for placement;
S302: adjusting an ultrasonic power to a preset value based on dimensions of the ceramic substrate and metal wire material properties of the fuse element;
S303: monitoring and adjusting a bonding pressure in real time by a pressure control system with pneumatic pressure feedback, such that the bonding pressure is uniformly distributed in contact areas between the fuse element and the two internal electrode components; and
S304: adjusting a bonding duration to a preset bonding time.

10. The manufacturing process for an ultra-miniature surface-mount fuse structure according to claim 6, wherein the thermocompression bonding in the step S3 comprises the following steps:
S311: adjusting a bonding temperature to a range of 150 °C to 250 °C by a heating structure and a temperature control system of a thermocompression bonding apparatus and setting temperature uniformity within ±2 °C;
S312: adjusting a heating temperature and an applied pressure based on metallic properties of the fuse element and the two internal electrode components to form an intermetallic compound layer at a contact interface between the fuse element and the two internal electrode components; and
S313: adjusting temperature, pressure, and time parameters based on a combination type of a fuse material of the fuse element and a material of the two internal electrode components to perform connection.
